(19) United States
(12) Patent Application Publication
(10) Pub. No.: US 2014/0351716 A1
(43) Pub. Date: Nov. 27, 2014

(54) Notes Page Sharing and Notification Features

(71) Applicant: Microsoft Corporation, Redmond, WA (US)

(72) Inventors: Nicole Steinbok, Sammamish, WA (US); Thomas Wionzek, Redmond, WA (US); David Tse, Kirkland, WA (US); David Rasmussen, Redmond, WA (US); Olga Veselova, Redmond, WA (US); Nathaniel M. Myhre, Kirkland, WA (US); Suresh Sitaula, Bellevue, WA (US); Sattawat Suppalertporn, Redmond, WA (US); Jonathan Yong-Chern Soh, Bellevue, WA (US); Hemalatha Sridharan, Redmond, WA (US); Philip Hu, Seattle, WA (US)

(73) Assignee: Microsoft Corporation, Redmond, WA (US)

(21) Appl. No.: 13/901,203

(22) Filed: May 23, 2013

(51) Int. Cl. G06F 3/0484

(52) U.S. Cl. CPC G06F 3/0484
USPC 715/753

(57) ABSTRACT

Embodiments provide notes application features including notes page sharing and notification features, but the embodiments are not so limited. In an embodiment, a computer-based method can be configured to provide a communication to one or more designated recipients, wherein the communication includes one of a view link to a shared page or an editable shared notes page or link thereto. A system of an embodiment includes a server computer configured in part to process notes page sharing requests as part of creating view links to shared notes pages and/or providing users with a means to collaboratively edit a shared notes page. A user interface of an embodiment is configured to share notes pages including displaying notification information regarding other user shared notes page views and/or edits. Other embodiments are included.

### BACKGROUND

Developers of electronic note taking or notes applications strive to provide intuitive user interfaces to allow users to enter typed text via keyboard or touchscreen, create tables, insert images, and scribe with free-form ink input on a notes page. Some note taking applications have different ways of saving electronic notes. For example, some note taking applications are configured to automatically save electronic notes while a user works, such as into organized notebook sections. One example note taking application interface is presented as a tabbed binder where a user can directly make notes and gather material from other applications. However, prior notes applications are not configured to enable sharing of notes pages that allow for user editing or notification features for shared notes page users.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide notes application features including notes page sharing and notification features, but the embodiments are not so limited. In an embodiment, a computer-based method can be configured to provide a communication to one or more designated recipients, wherein the communication includes one of a view link to a shared page or an editable shared notes page or link thereto. A system of an embodiment includes a server computer configured in part to process notes page sharing requests as part of creating view links to shared notes pages and/or providing users with a means to collaboratively edit a shared notes page. A user interface of an embodiment is configured to share notes pages including displaying notification information regarding other user shared notes page views and/or edits. Other embodiments are included.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing or communication architecture used in part to provide a rich electronic notes application including notes page sharing and/or notification features.

FIG. 2 is a flow diagram depicting an exemplary process of using a notes application to share a notes page with one or more other users.

FIGS. 3A-3Q depict notes page sharing and notification implementation examples.

FIG. 4 is a flow diagram depicting an exemplary process of providing a view link for a shared notes page.

FIG. 5 is a flow diagram depicting an exemplary process of enabling a user to share a notes page with one or more other users that are permitted to edit the shared notes page.

FIG. 6 is a block diagram illustrating an exemplary computing environment for implementation of various embodiments described herein.

FIGS. 7A-7B illustrate a mobile computing device with which embodiments may be practiced.

FIG. 8 illustrates one embodiment of an architecture of a system implementing note sharing features with one or more client devices.

### DETAILED DESCRIPTION

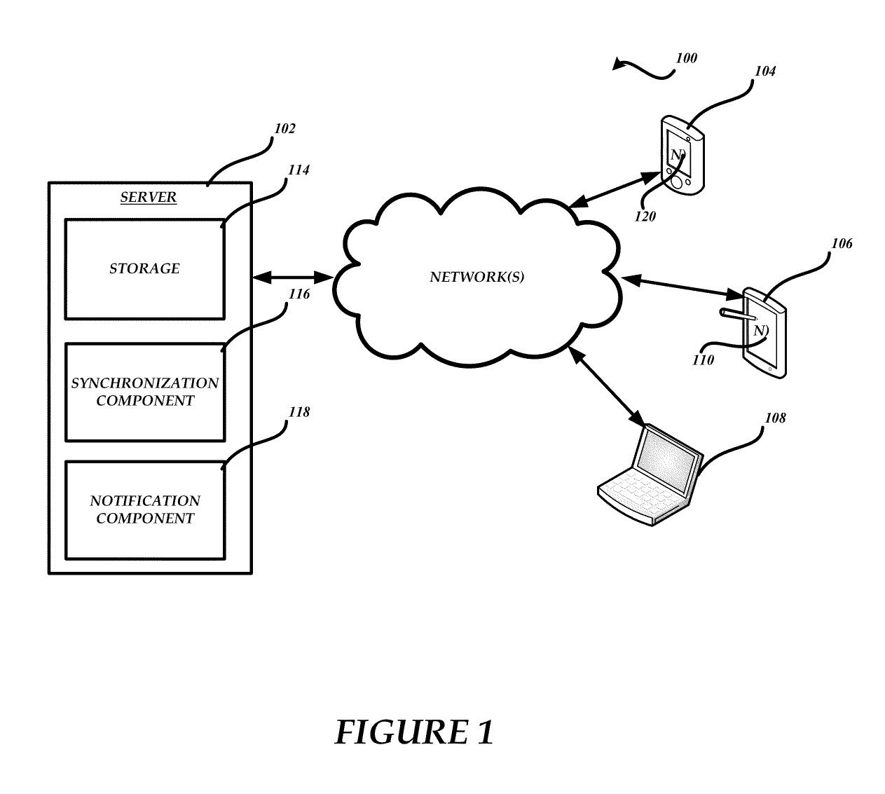

FIG. 1 is a block diagram of an exemplary computing or communication architecture 100 used in part to provide notes page sharing and/or notification features, but is not so limited. As shown in FIG. 1, the exemplary architecture 100 includes at least one server computer 102 coupled to a plurality of example client devices, such as smart phone 104, tablet computer 106, and laptop computer 108. While one server is shown, it will be appreciated that complex communication architectures typically employ multiple server computers, networking components, and other hardware and software components. Components of the architecture 100 can communicate and interact by way of wired and/or wireless networks. Moreover, it is possible for users to commonly employ multiple portable devices, each running a notes application. As described below, a browser or other application can be used to interact with shared notes pages but may not include each and every feature of an installed notes application.

For this example, tablet computer 106 includes a notes application 110 that includes a notes page sharing module or component. Features of the notes application 110 can be provided as part of an add-in, source, or other component. The notes application 110 of an embodiment can be configured to operate at an O/S level. The notes application 110 and notes page sharing component of an embodiment includes complex programming code configured to impart the page sharing and note taking functionality. The notes application 110 and notes page sharing features can be used to share a notes page such that other users can view and/or edit a shared version or copy of an original notes page. The server 102 of an embodiment includes a storage component or storage 114, synchronization component 116, and a notification component 118.

Storage 114 of an embodiment is configured to store information used by the server 102 as part of facilitating the sharing of notes pages and/or providing viewing and/or editing information for display using a notes application interface, browser, or other interface. The server 102 can push information to each client for display while interacting with a shared notes page. The storage 114 of one embodiment is configured to store one or more of page-level permissions, shared notes page instance information, and/or notes page metadata which can be used in part by the synchronization component 116 to manage the updating or maintenance of shared notes pages following user edits or other operations.

Storage 114 or some other component can be configured to store page-level sharing permissions for each shared notes page, enabling control over amounts of user interaction available for a particular user, such as designated shared notes page viewers and editors. As described below, a notes application can be configured to enable creation of a view link along with page-level view permissions to allow designated users to view a shared notes page or invite other users to edit a shared notes page along with any associated page-level editing permissions. A notes application or browser can be used to view and/or edit a shared notes page based in part on associated page-level sharing permissions for each user.

The synchronization component 116 can use information stored in storage 114 as part of providing the most up to date version of a shared notes page. For example, the storage 114 can be configured as cloud storage allowing the synchronization component 116 to efficiently retrieve update and/or other information associated with a shared notes page when performing synchronization operations. The synchronization component 116 can operate to synchronize multiple instances of a shared notes page rendered on various user devices/systems, such as smart phones, tablet computers, laptop computers, and/or other processor-based devices/systems.

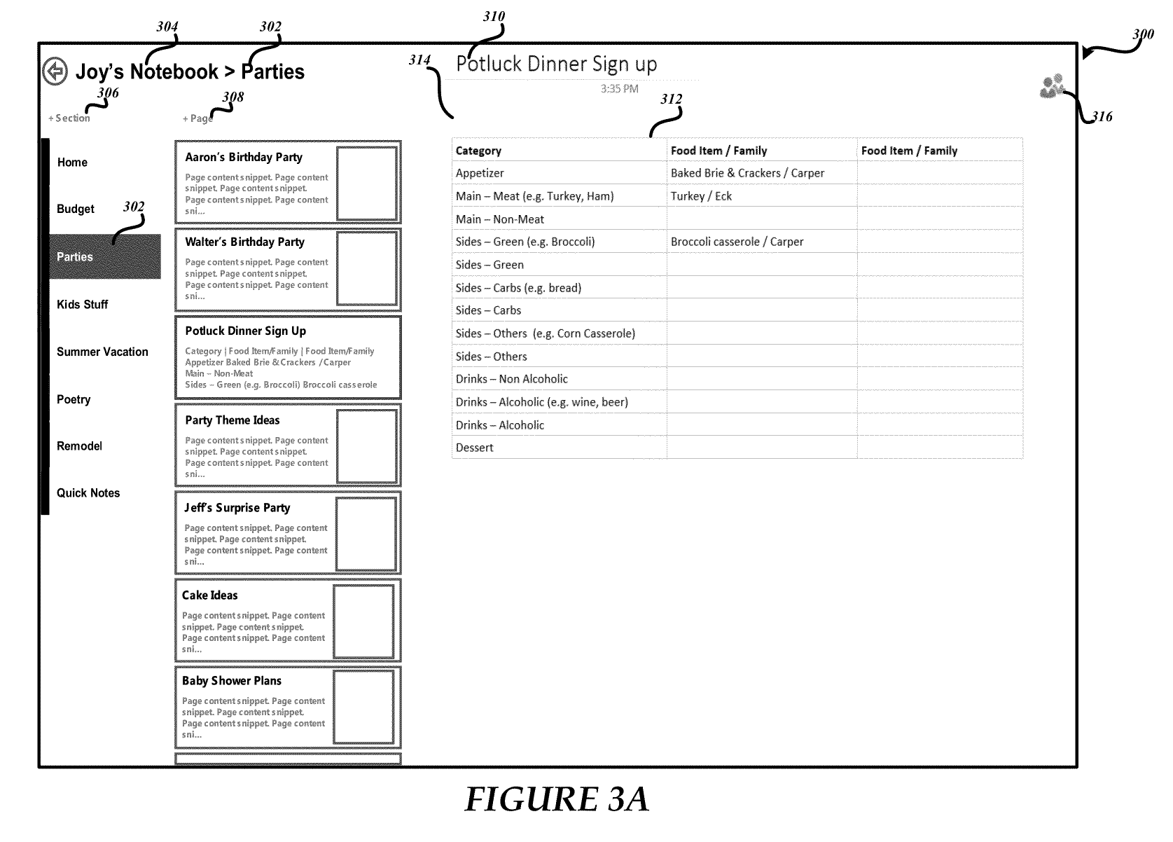

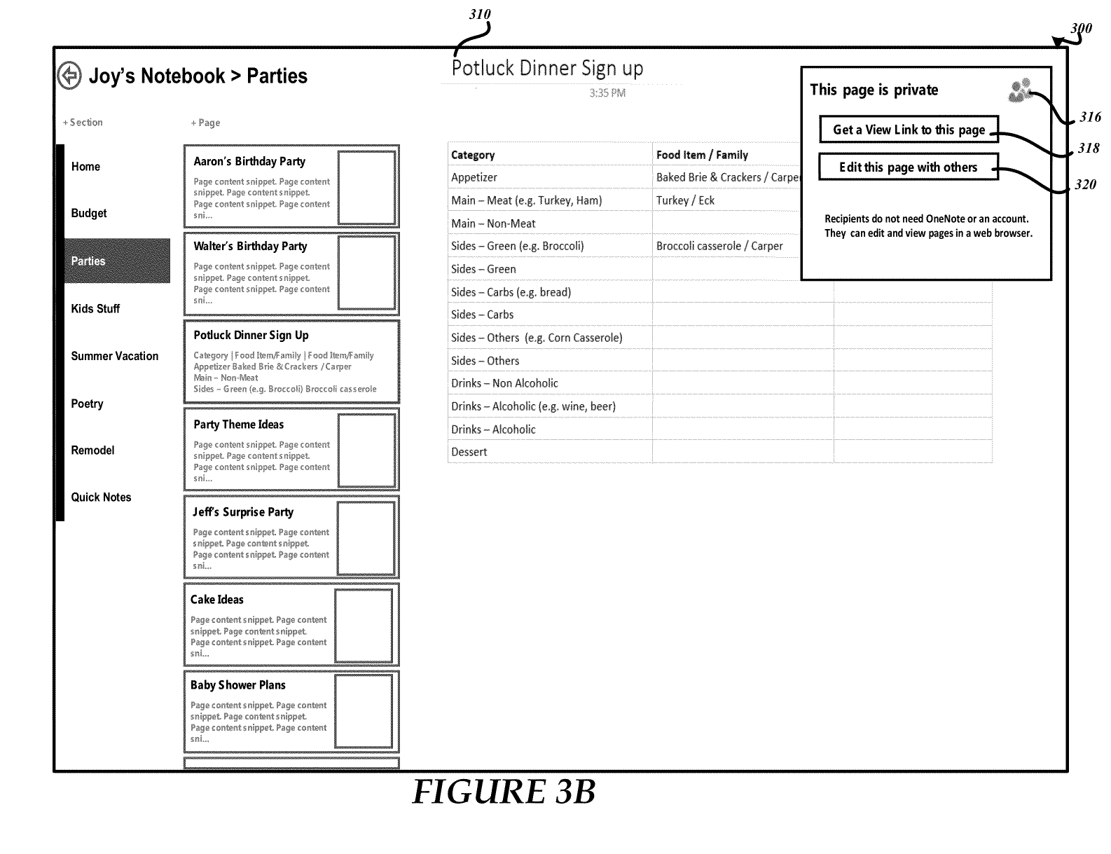

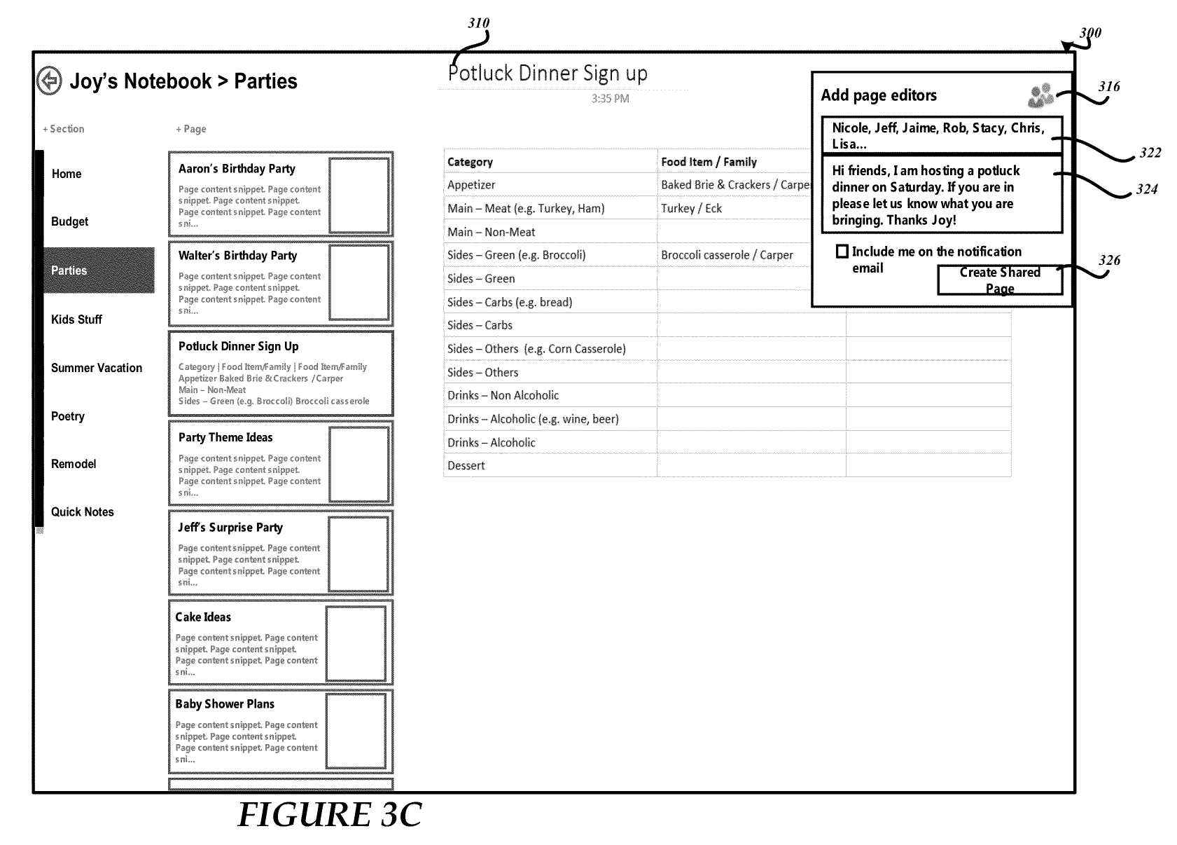

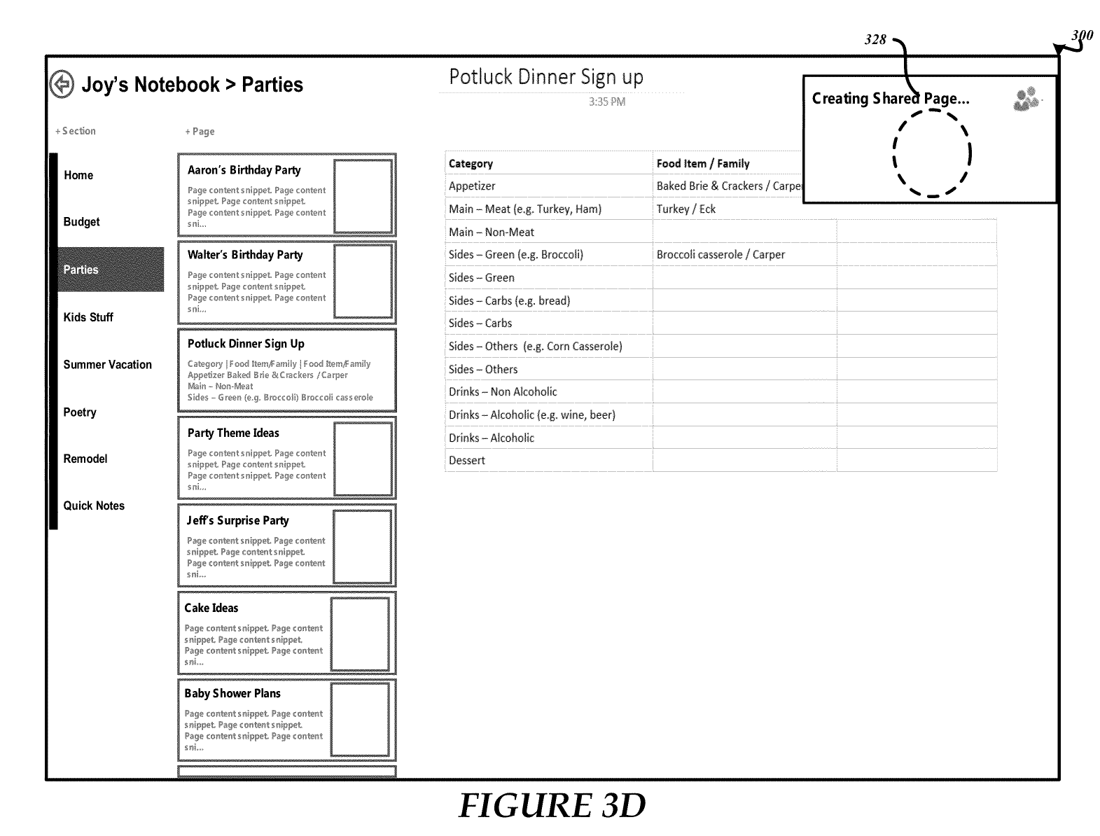

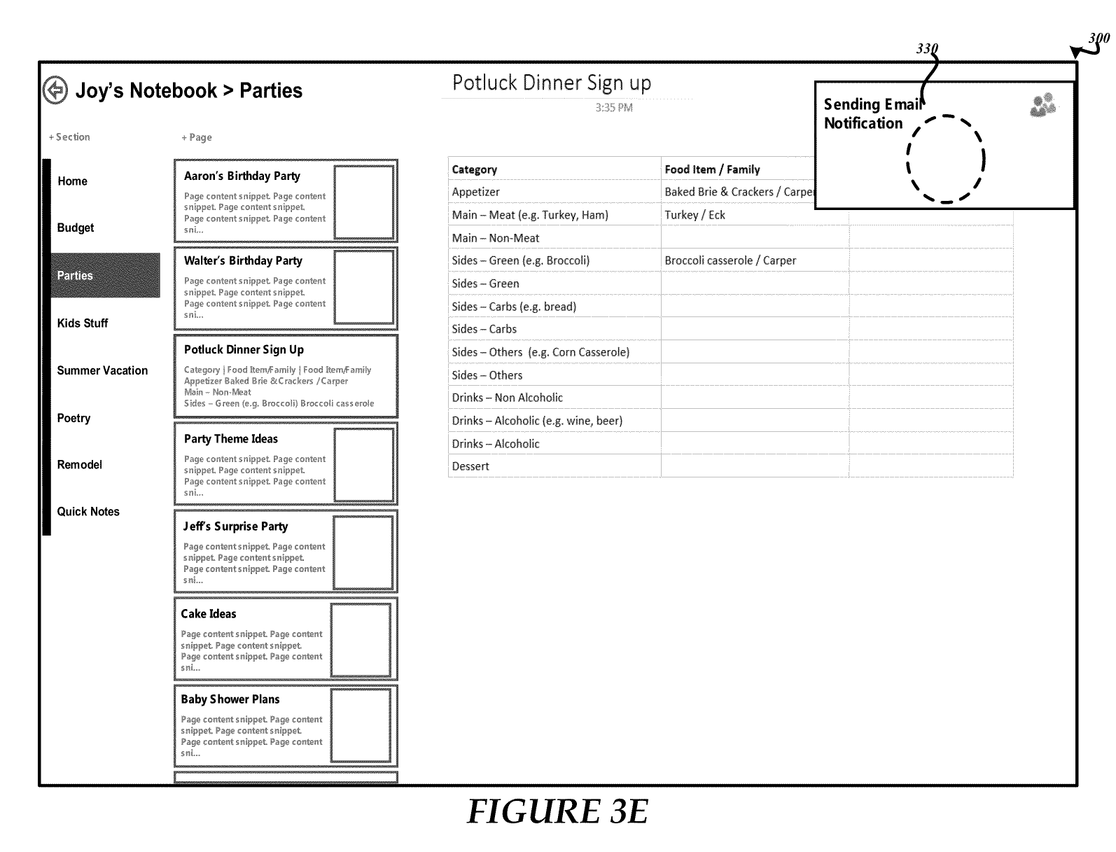

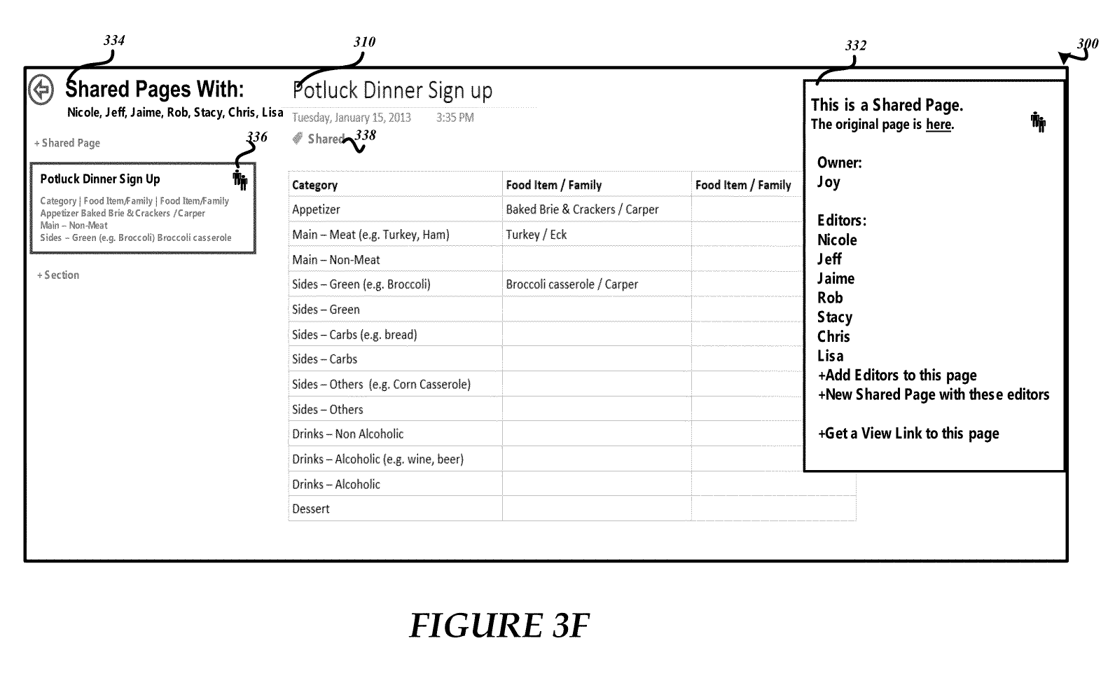

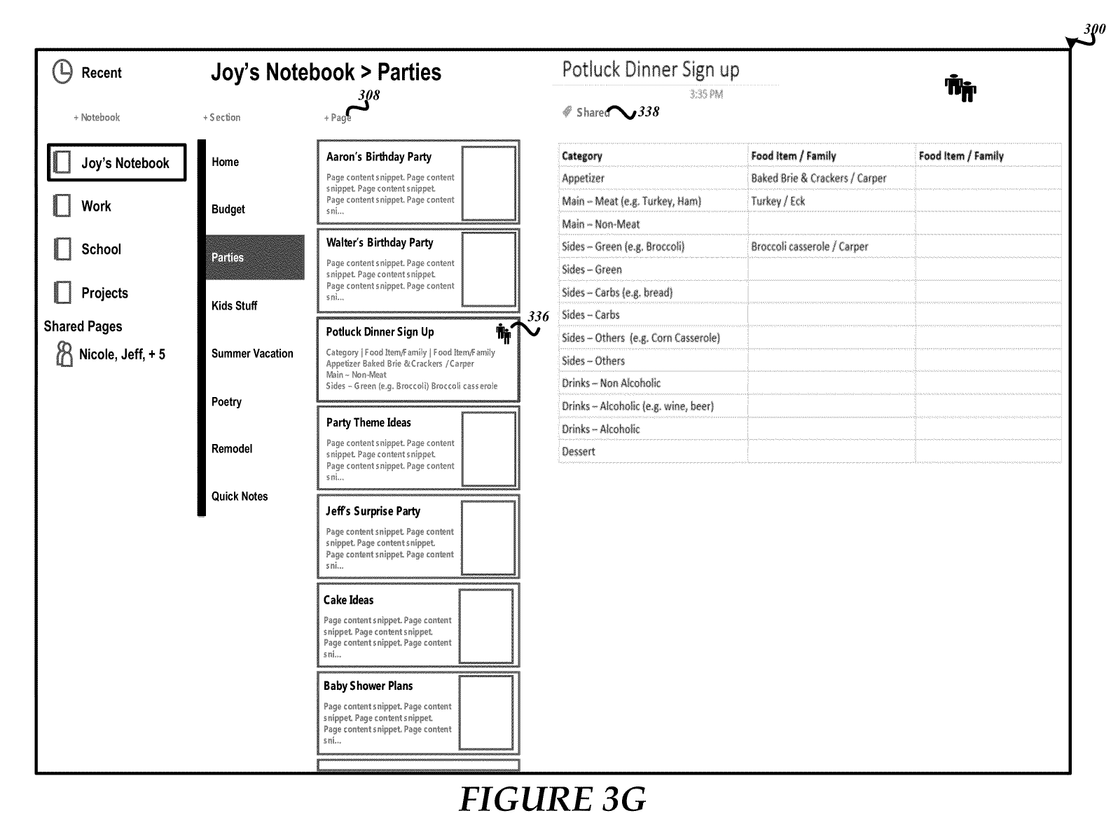

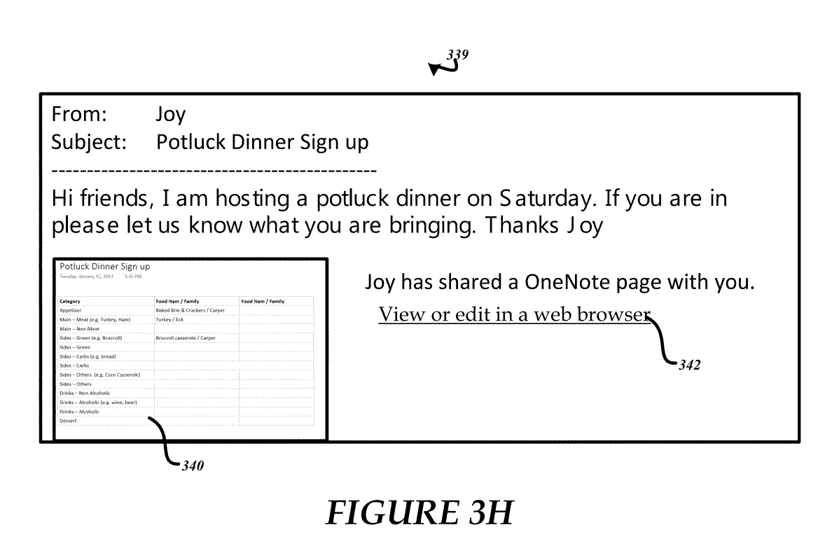

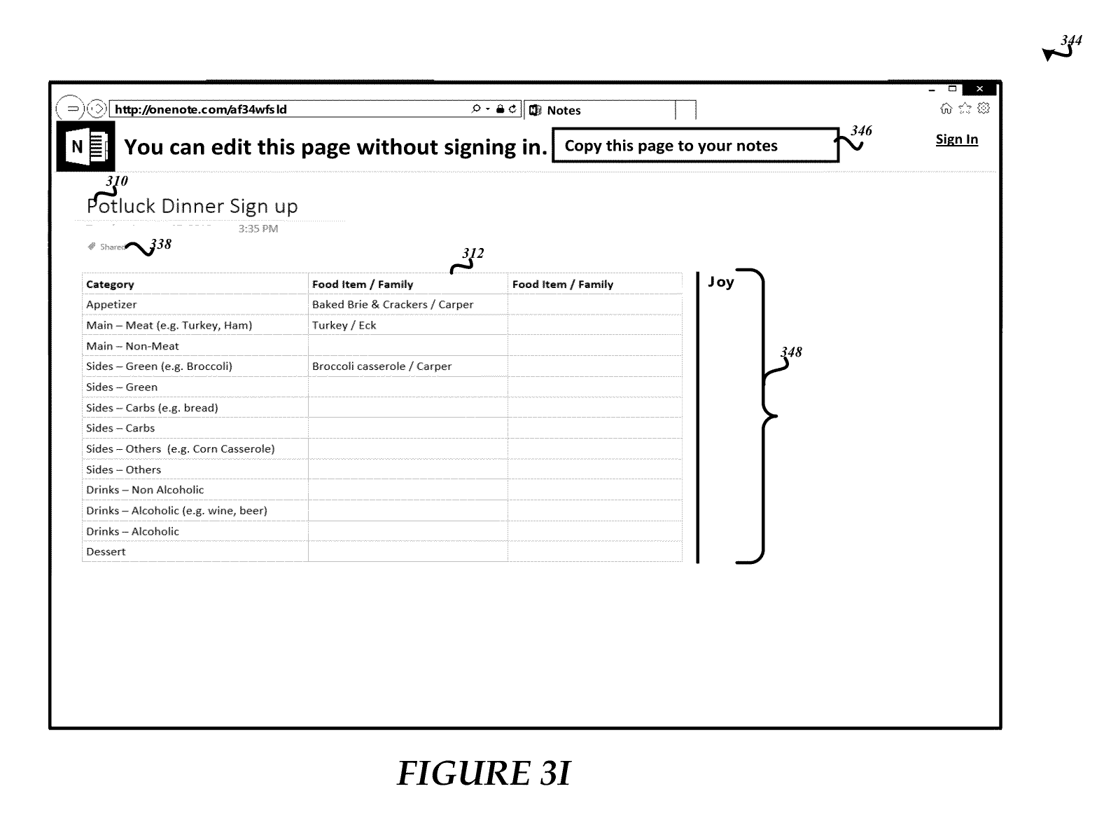

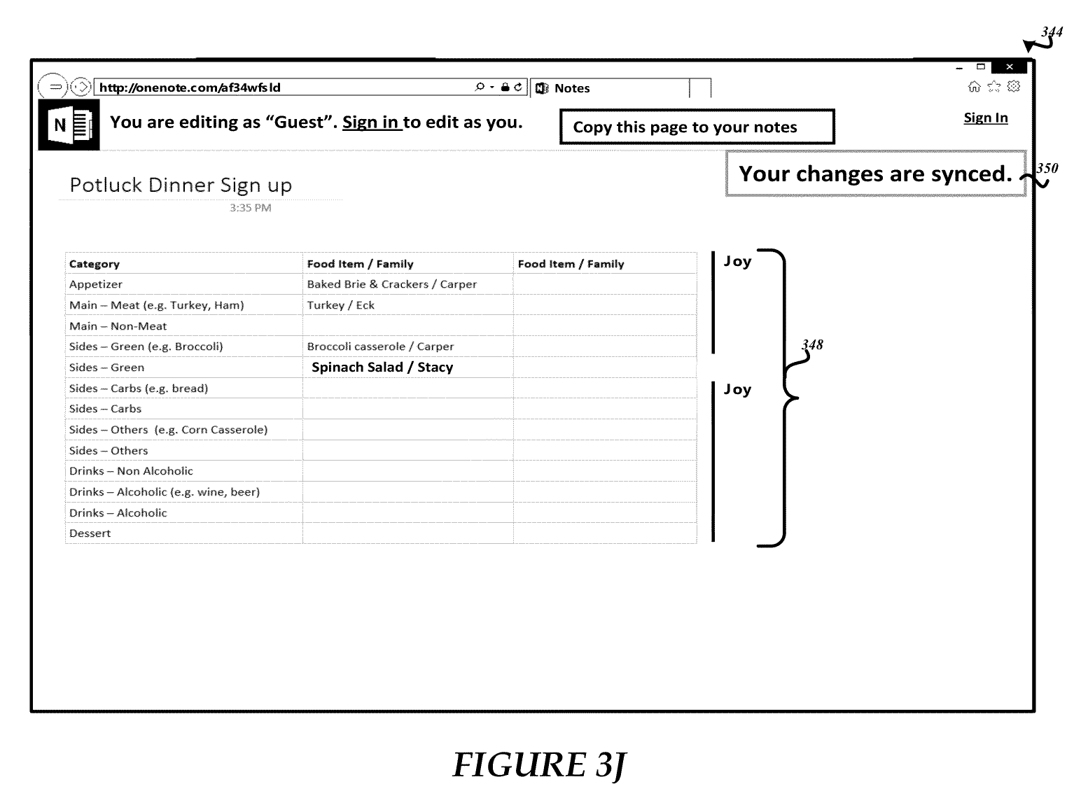

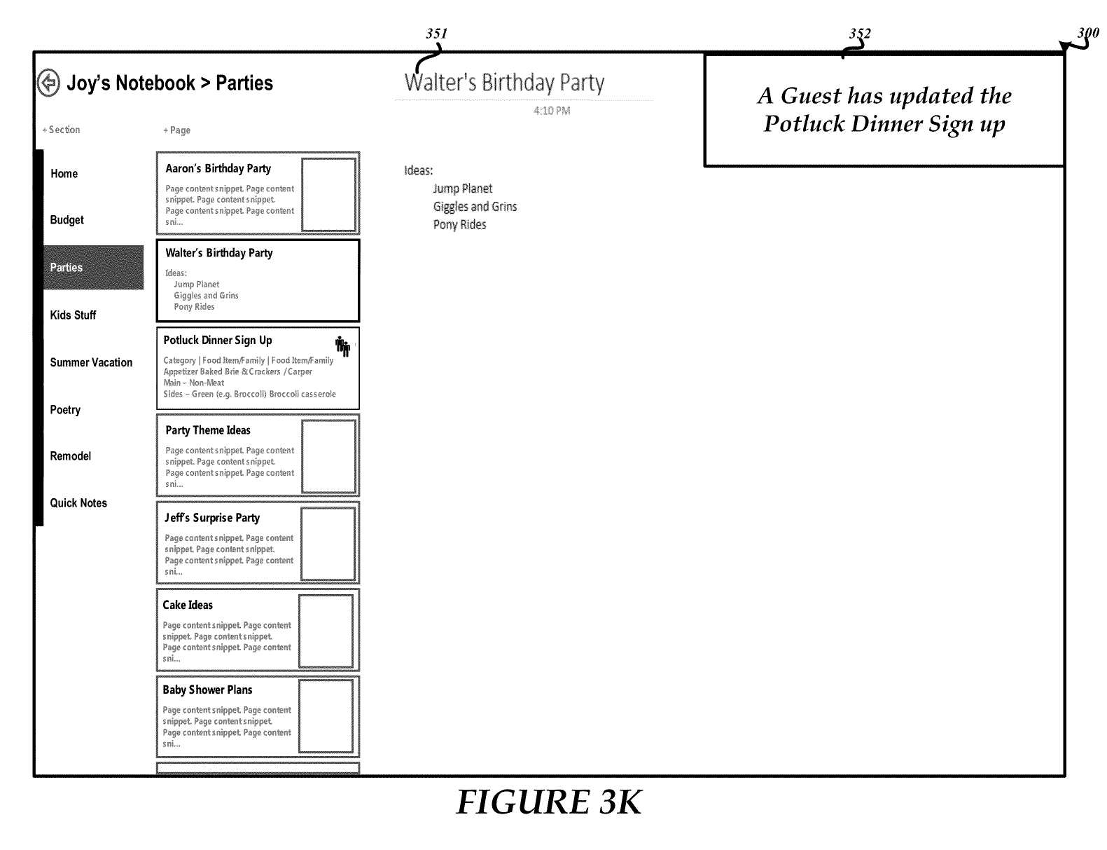

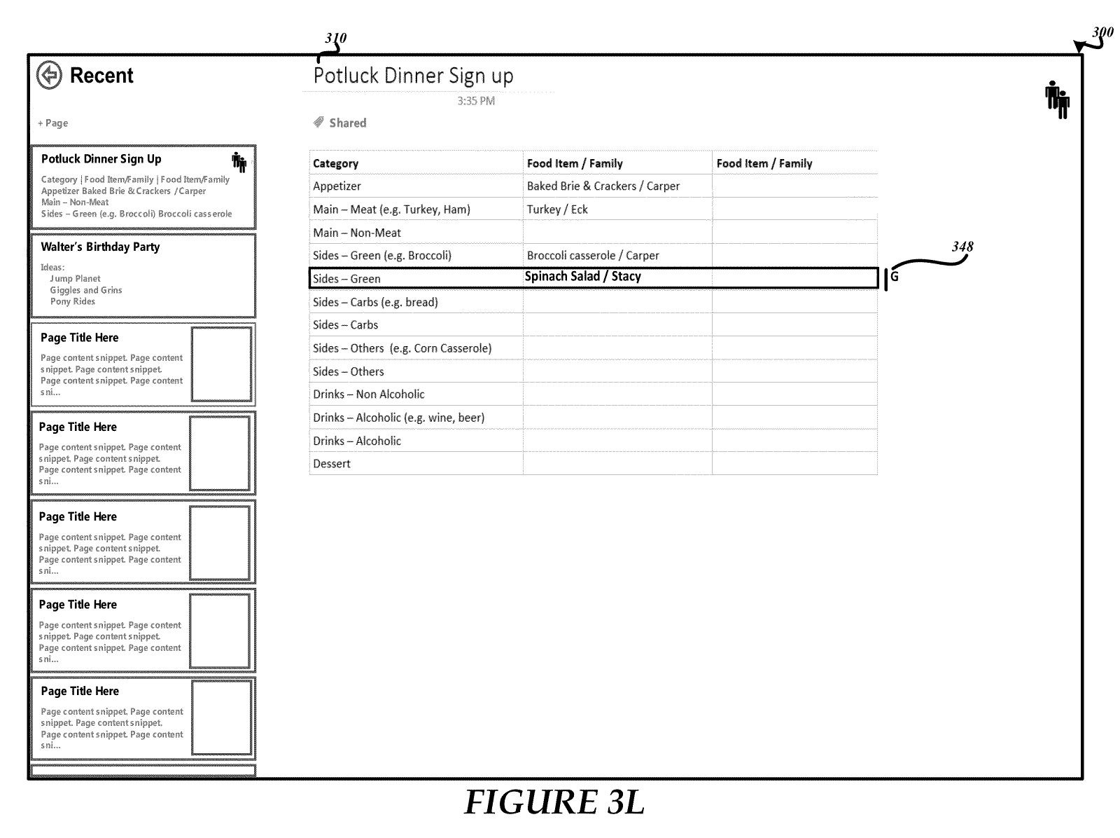

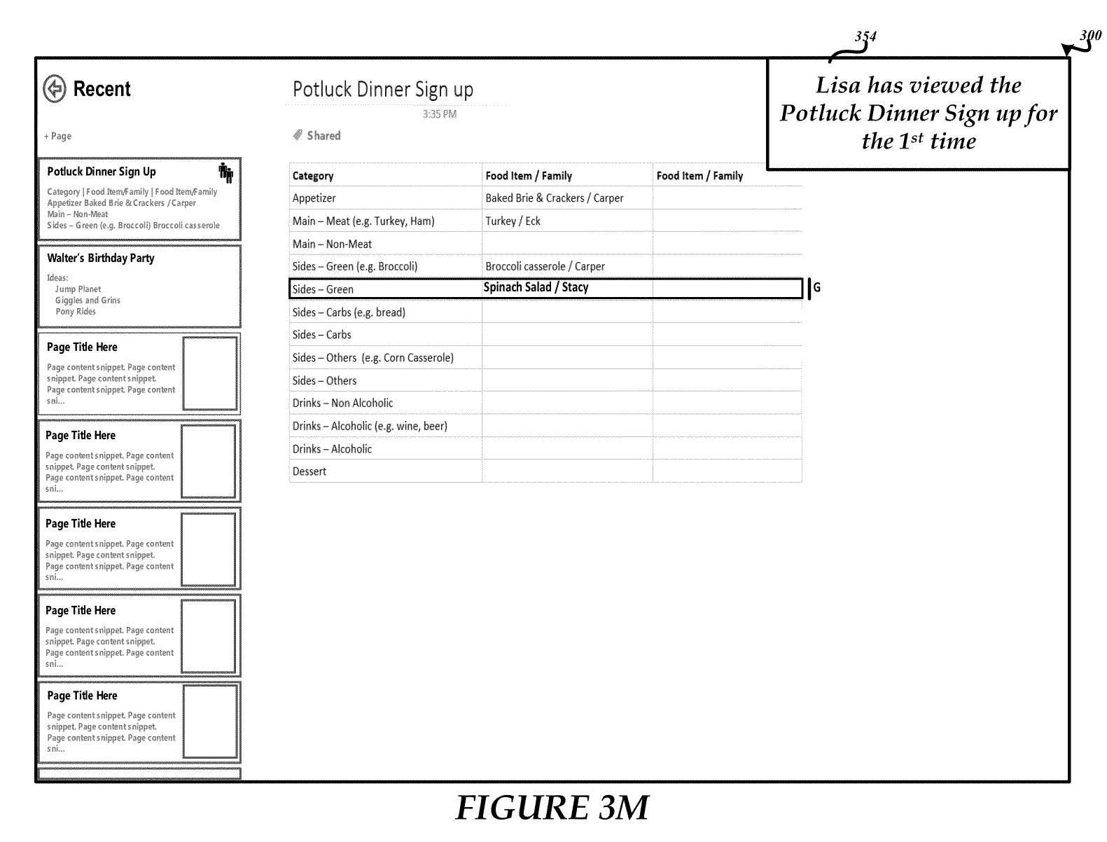

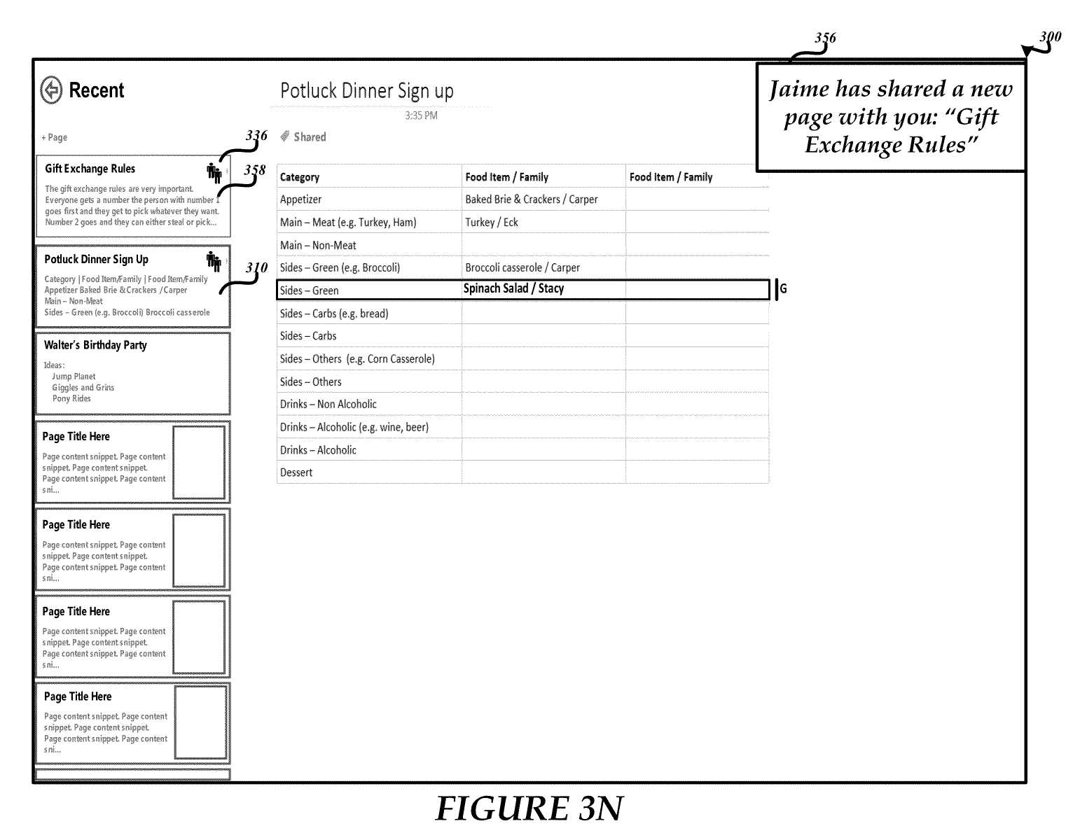

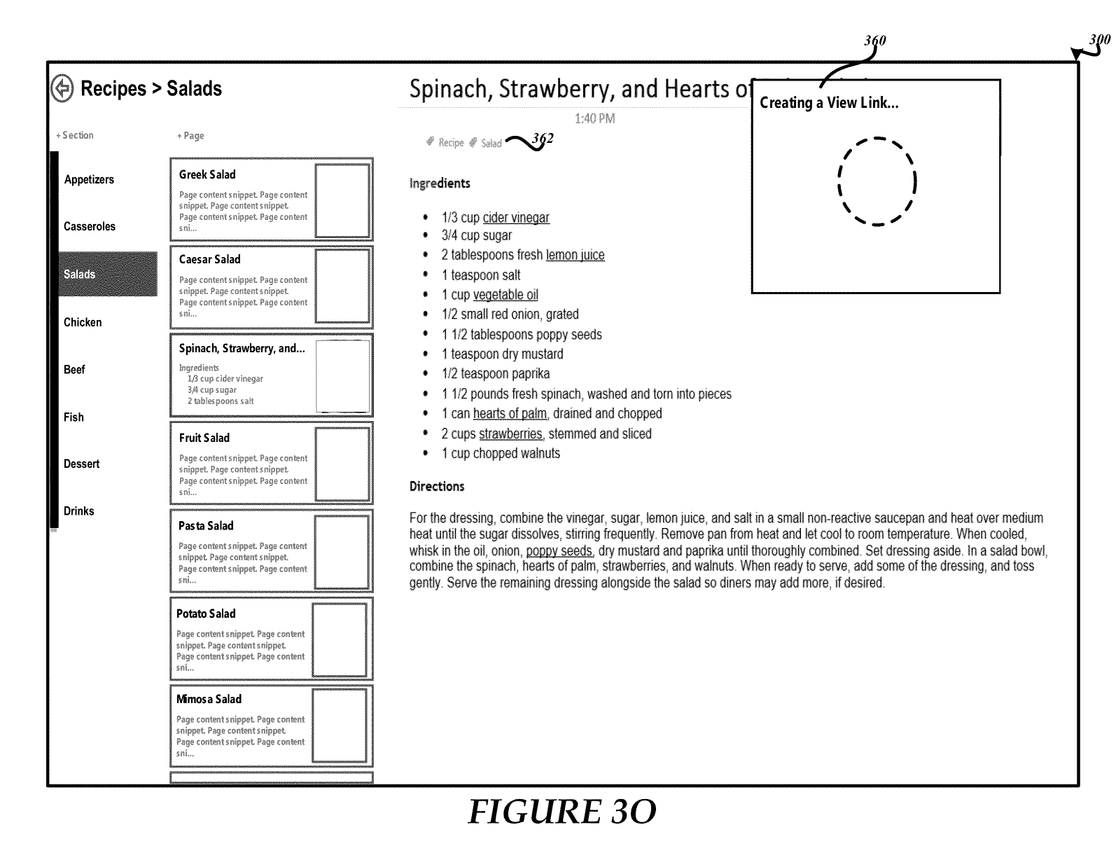

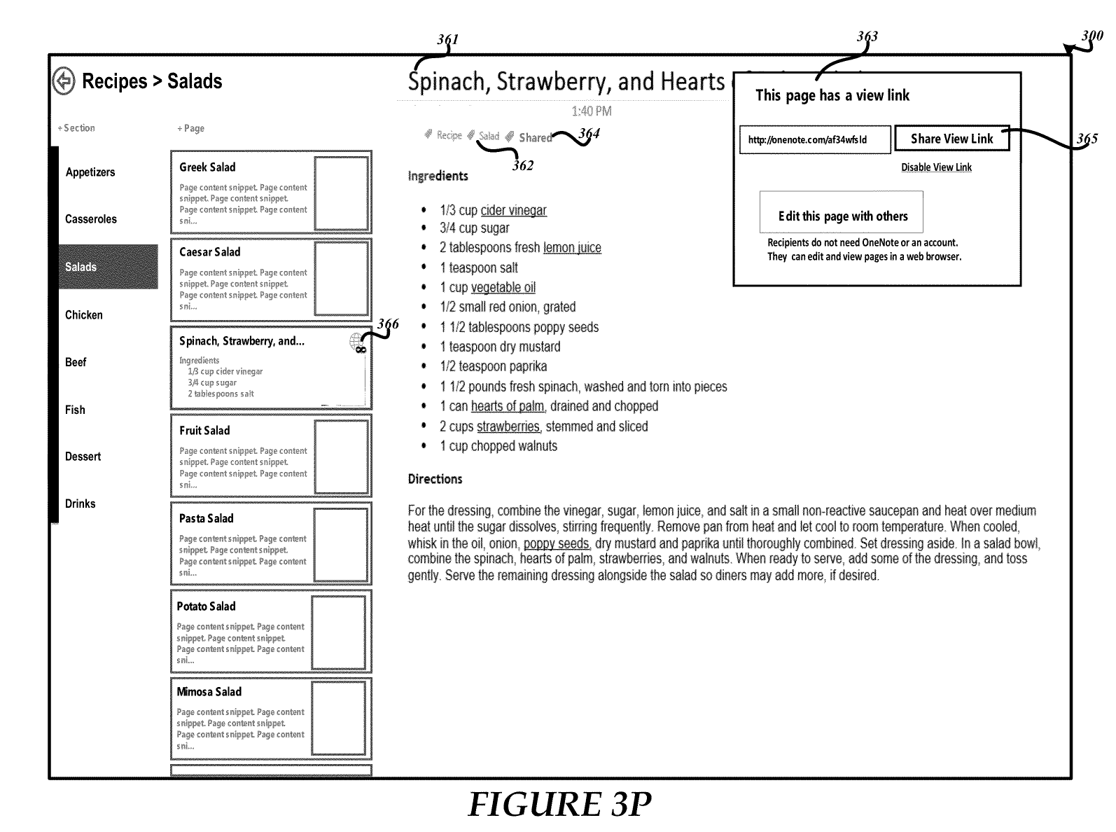

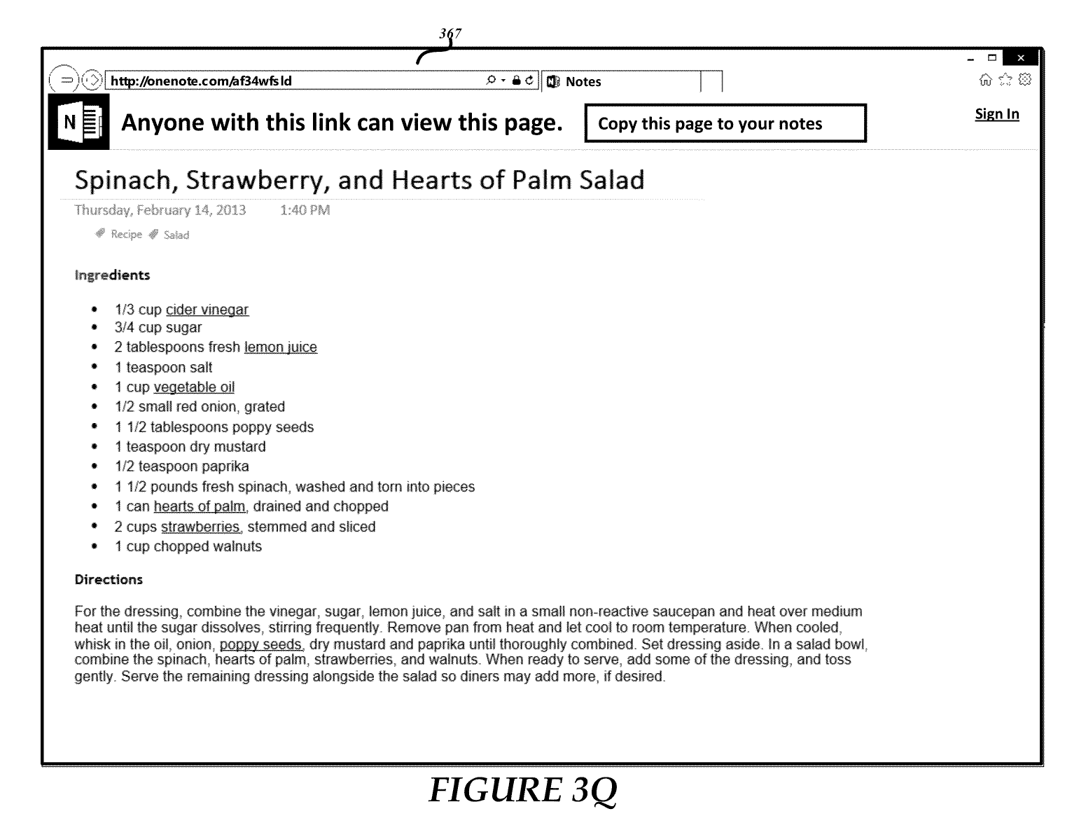

The notification component 118 of an embodiment is configured to generate notification information as the server 102 receives interaction information from various clients, such as notes page views or changes associated with shared notes page edits for designated shared notes page users. As an example, the notification component 118 can operate to generate an email, text message, or some other communicative notification that informs a notes application or browser user of another user's view, edit, sharing, and/or other shared notes page interaction or operation (see FIGS. 3I-3N for example). In some embodiments, the components of server 102 may be included as standalone components or distributed in various combinations.

According to an embodiment, implementing shared notes page viewing features does not require permissioning users to view an associated notebook that includes a shared or to be shared notes page. In one embodiment, permissions are implemented at the page-level or file level. Alternatively, permissions may be provided and hosted at the notebook level (e.g., folder with one or more files), section level (e.g., single file), and/or some other level using a dedicated server to ensure that each user only has permissions to view a shared notes page. For example, a view link can be configured to include a special token used to control viewing of a shared notes page targeted by a view link. According to an embodiment, implementing shared notes page editing features includes moving a copy of a source notes page to a new section or new notebook and activating the associated permissions. In an embodiment, when an editing user chooses to copy the shared notes page to personal notes, a link associated with the original notes page is maintained and/or stored.

As an example, the laptop computer 108 user may prefer to use a browser to view and edit notes pages while the smart phone 104 user prefers to use a notes application 120 tailored for the mobile device. It will be appreciated that current portable computing devices include the capability of communicating with the server 102 whether over a cellular network, WiFi network, or some other network or combination of networks. Depending in part on the device type, the particular notes application may be configured to include different UI features and provide different notification types, such as sounds, visual notifications, haptic feedback, etc. In an embodiment, the notes applications 110 and 120 are configured with complex programming code that enables the creating and sharing of notes pages as well as display capabilities to convey information regarding other user interactions with a shared notes page.

The client devices/systems described herein can be configured with at least one processor, system memory, and networking components. System memory can include volatile (e.g. random access memory (RAM)), non-volatile (e.g. read-only memory (ROM)), flash memory, etc. System memory can include an operating system, a notes application, and other application programs that provide rich interactive functionality for the respective devices/systems. It will be appreciated that embodiments described herein may also be practiced in conjunction with other operating systems, device/system types, and/or other application programs. As will be appreciated, the client device/systems use the networking functionality to communicate and utilize functionality of remote systems, such as various servers and/or remote storage farms or locations. The client/system uses the processor to process complex programming code associated with the notes page sharing and notification functionality.

Various embodiments can be used with a number of computer configurations, including hand-held devices, multiprocessor systems, microprocessor-based or programmable consumer electronics, minicomputers, mainframe computers, etc. Various embodiments can be implemented in distributed computing environments using remote processing devices/systems that communicate over a one or more communications networks. In a distributed computing environment, program modules or code may be located in both local and remote memory. Various embodiments can implement system-on-a-chip (SOC) features that may include one or more processors, graphics components, communication components, etc. For example, a SOC can include a central processing unit, a graphics processor, memory, USB controller, power management circuits, wireless radio(s) (WiFi, cellular, etc.), and/or other components. Various embodiments may be implemented as a process or method, a system, a device, or computer readable storage for example.

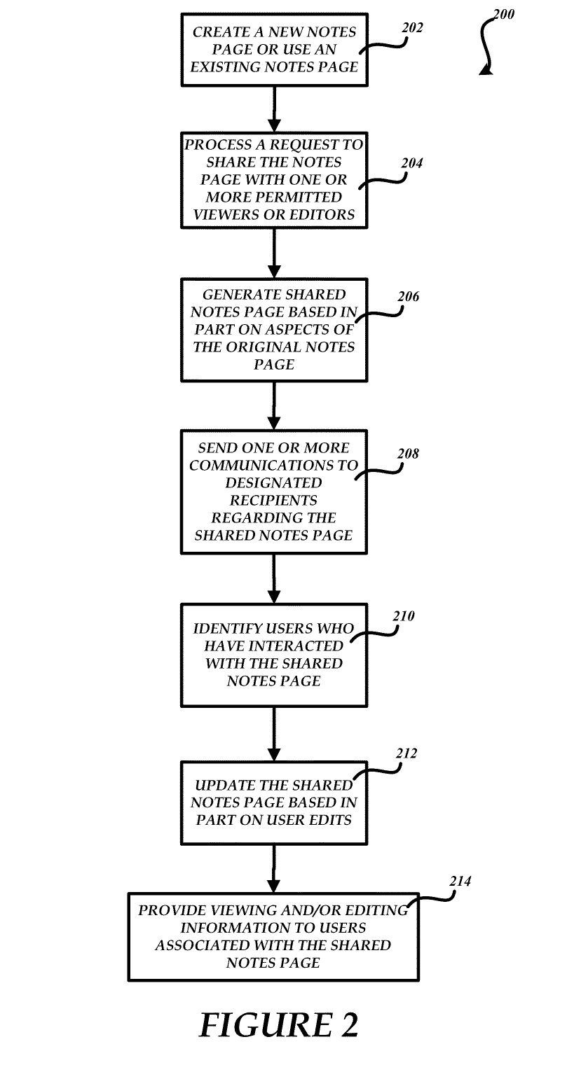

FIG. 2 is a flow diagram depicting an exemplary process 200 of using a note-taking or notes application to share a notes page with one or more other users. The process 200 of an embodiment can be used to share a notes page such that other users may view or edit the shared notes page depending in part on page-level sharing permissions. As described below, the process 200 can be used to create a view link to allow designated users to view a shared notes page and/or enable designated users to edit a shared notes page. A notes application or browser can be used to view or edit a shared notes page based on the associated page-level sharing permissions. The process 200 can incorporate the use of an electronic computing device, such as a smart phone or tablet computer for example, and complex programming in part to provide notes page sharing functionality. A notes application interface can be configured with executable code that functions in part to enable the sharing of notes pages between users.

With continuing reference to FIG. 2, at 202 the process 200 begins when a user uses a notes application interface to create a new notes page or use an existing notes page that includes original content and/or one or more original notes page tags. The process 200 is also operable to create shared notes pages that are blank or new that can be shared for viewing and/or editing by one or more designated users. For example, a user can use a tablet computer with an installed notes application to open an existing notes page from local storage or cloud storage and select a notes page sharing command to share the particular notes pages. A cloud-based storage system can include one or more server computers that operate to store and/or synchronize notes page updates and modifications.

At 204, the process 200 operates to process a request to share the notes page with one or more permitted viewers and/or editors. In an embodiment, the process 200 at 204 includes the use of a notes application interface to display a sharing icon or other selectable UI control that can be actuated (e.g., tapped, clicked, etc.) to display a UI dialog allowing the user to send a request to create a view link for viewing a shared notes page or designate other user editors permitted to edit an associated notes page (see FIG. 3B for example). As an example, a UI dialog can be configured to receive user input regarding other user identities (e.g., email address or alias, mobile phone number, etc.) that will be permitted to view and/or edit an associated shared notes page. The notes application interface of an embodiment can be configured to use integrated email or other messaging functionality to send communications to permitted viewing or editing users, including a view link to a shared notes page or an editable notes page via email, text messaging, or some other mechanism.

At 206, the process 200 operates to generate a shared notes page along with page-level view and/or edit permissions based in part on aspects of the original notes page. For example, a dedicated sharing server can be used to process a notes page sharing request and host or provide a copy of an original notes page along with the corresponding page-level sharing permissions for the permitted viewing or editing users. In one embodiment, the process 200 at 206 operates to transfer the original content, metadata, and/or one or more original notes page tags to the shared notes page copy. A dedicated server or servers can be use notes page instances associated with editing users to synchronize changes to the shared notes page. In one embodiment, the process 200 does not operate to transfer a shared tag associated with the original notes page, wherein a shared tag is only added to the shared notes page when each user affirmatively shares the shared notes page with other users.

At 208, the process 200 operates to send one or more communications to one or more of the designated recipients. For example, the process 200 at 208 can use an email server or text messaging server to send communications to one or more shared notes page viewing and/or editing users along with a link to the shared notes page. The process 200 at 208 can also attach a copy of the shared notes page with the page sharing informing/alerting communication. At 210, the process 200 operates to identify users who have viewed and/or edited the shared notes page. For example, the process 200 can use click-through or similar operations to track user views and/or edits, viewer and editor identity information, and/or click-through or interaction information associated with each shared notes page.

If the shared notes page has been edited, the process 200 at 212 operates to update the shared notes page with the user edits. The process 200 may track or maintain page instances for each editing user as part of synchronizing changes to the shared notes page and propagating the edits to page editors in order to have the latest version of the shared notes page. For example, cloud storage synchronization features may receive and process user edits at different times. At 214, the process 200 operates to provide view and/or edit information to one or more users associated with the shared notes page, such as one or more of the designated users and/or the notes page originator for example. For example, notifications may only be provided to signed-in users with the shared notes page in focus or while a notes application is active. Depending on the user, each user may receive different notifications of shared notes page views and/or edits. While a certain number and order of operations is described for the exemplary flow of FIG. 2, it will be appreciated that other numbers and/or orders can be used according to desired implementations.

FIGS. 3A-3Q depict notes page sharing and notification implementation examples. The implementation example includes use of an installed notes application (e.g., ONENOTE notes application) on a tablet computer (e.g., SURFACE device), smartphone, or other computing device/system. As described above, each user is not required to have an installed notes application and other applications, such as a browser or other UI application can be configured with notes page sharing and notification functionality. For example, a browser application can be used to interact with a shared notes page, including enabling the viewing and/or editing of a shared notes page along with display of shared notes page interactions by other users.

As described below, aspects of a notes application user interface (UI) 300 can be used to share notes pages such that other users can edit and/or view the shared notes pages. The notes page sharing functionality can be used to allow users to identify permitted page editor(s) or viewer(s), including notifying the users of shared notes page editing and/or viewing permissions or abilities. For example, once a shared page is created (locally and/or remotely), page-level permissions can be used to control whether an invited user will be able to edit a shared notes page or view the shared notes page. Logged-in users are able to store a copy of a shared notes page to a personal notebook (including private and public storage options) and share the shared notes page with other designated users.

FIG. 3A depicts an exemplary notes application UI 300 configured with complex programming code that enables rich functionality associated with the sharing of notes pages. While one example interface layout or architecture is shown, it will be appreciated that the notes application UI 300 can be configured in different implementations. The exemplary notes application UI 300 includes a number of layout regions or areas configured to display aspects of a user electronic notebook. For this example, the user has selected the Parties section 302 of Joy's Notebook 304.

As shown in FIG. 3A, the section region 306 displays the various notebook sections. The page list region or page list 308 includes a number of pages of the Parties section 302. The user has opened the Potluck Dinner Sign Up page 310 which has caused the notes application UI 300 to render a sign-up chart 312 in a content region 314 of the notes application UI 300. The notes application UI 300 includes a page share interface portion or actuator 316 that can be used (e.g., tapped, clicked, etc.) to share the current or in focus notes page, the Potluck Dinner Sign Up page 310 for this example. At this point, the Potluck Dinner Sign Up page 310 is unshared and is not highlighted as being shared using a notes page shared tag (described below).

FIG. 3B depicts the notes application UI 300 after the user has actuated or hovered over the page share actuator 316. In an embodiment, actuation of the page share actuator 316 operates to execute code to inform the user that the Potluck Dinner Sign Up page 310 is private while presenting one or both of generating a view link to the page control 318 or an edit the page with others control 320. Optionally, use of the page share actuator 316 can inform the user that page share recipients can use a browser or some other application to open, view, and/or edit notes pages. A user can select the generating a view link to the page control 318 which causes code to execute as part of providing a view link to the Potluck Dinner Sign Up page 310 for designated users. As discussed further below, recipients of the view link can use the view link to view the Potluck Dinner Sign Up page 310 in a browser, notes application, or other application. Alternatively, a user can select the edit the page with others control 320 to enable one or more other users to edit the shared notes page.

FIG. 3C depicts the notes application UI 300 after the user has selected the edit the page with others control 320 which caused execution of code to display a dialog or interface that allows the user to enter identification information in box 322 of one or more other recipient users designated as having permission to edit the Potluck Dinner Sign Up page 310. In an embodiment, actuation of the edit the page with others control 320 causes execution of code that enables the user to input recipient identification information (e.g., email address or alias) to use when informing each user of a newly shared page. The identification information can also be used to provide individual notifications as to when a page has been edited and/or viewed. The user can optionally enter a message regarding the Potluck Dinner Sign Up page 310 in box 324 before using selector/actuator 326 to create the shared notes page with page-level editing permissions for the entered or designated recipients.

FIG. 3D depicts the notes application UI 300 displaying a dialog 328 to inform a user that the notes application or server is creating a shared notes page that identifies the designated recipients as having page-level editing permissions. As described above, the page-level permissions can be stored locally and/or remotely for use in enabling the designated recipient editors to edit the shared notes page, the Potluck Dinner Sign Up page 310 for this example.

FIG. 3E depicts the notes application UI 300 displaying a dialog 330 to inform a user that an email is being sent to the designated editors. It will be appreciated that the information provided via dialogs 328 and 330 can be combined in a single dialog. While an email type notification is shown in FIG. 3E, other notification types can be used such as via text messaging, via a notification bar or area, via voicemail, etc.

FIG. 3F depicts the notes application UI 300 after a successful notes page sharing operation. As shown, in FIG. 3F, a dialog 332 is presented to inform the user that the page is now shared and a link is provided to the original notes page. The dialog 332 displays the owner (e.g., Joy) along with permitted editors (e.g., Nicole, Jeff, Jaime, Rob, Stacy, Chris, and Lisa). The user can use controls of the dialog 332 to add editors for the now shared Potluck Dinner Sign Up page 310, create a new shared page with the current editors, and/or get a view link to the Potluck Dinner Sign Up page 310. After the successful notes page sharing operation, a shared page list or view 334 has been updated with a shared page editing indicator 336 to inform the user (Joy) of the shared editing status of the Potluck Dinner Sign Up page 310. The content region 314 has also been updated to include a shared notes page tag 338 indicating the now shared status of the Potluck Dinner Sign Up page 310.

FIG. 3G depicts the notes application UI 300 after Joy has navigated back to a home notes view. The now shared Potluck Dinner Sign Up page 310 is displayed with the shared page editing indicator 336 among the other listed pages that are currently unshared. The content region continues to display the shared notes page tag 338 for the Potluck Dinner Sign Up page 310.

FIG. 3H depicts an email notification 339 example sent to a recipient editing or viewing user. For this example, a preview 340 of the Potluck Dinner Sign Up page 310 is displayed with the message input by Joy asking for input regarding items to bring to the potluck dinner. The email notification 339 includes a link 342 for the user to use to view or edit the shared Potluck Dinner Sign Up page 310. As described above, in accordance with an embodiment, page-level permission settings control whether users are able to view and/or edit the shared Potluck Dinner Sign Up page 310.

FIG. 3I depicts a browser interface 344 after one of the recipient editors clicked or activated the link 342. The browser interface 344 renders the content of the shared Potluck Dinner Sign Up page 310 including the shared notes tag 338 and the sign-up chart 312. In the browser application mode, and for this example, a page copy control 346 enables the user to copy the Potluck Dinner Sign Up page 310 to the user's personal notes or other note location. The shared Potluck Dinner Sign Up page 310 includes additional collaboration information. For this example, assigned to status information 348 is rendered adjacent to the sign-up chart 312 to inform the user that another user has edited the sign-up chart 312 of the Potluck Dinner Sign Up page 310 (currently only Joy is assigned to all list items for this example). It will be appreciated that other types of applications may be configured to activate the link 342 to view or edit the sign-up chart 312. As shown, the shared Potluck Dinner Sign Up page 310 is editable as a guest or the user can sign-in to identify the user with any associated edits.

FIG. 3J depicts the browser interface 344 after the editing user has made an edit to the sign-up chart 312 (added a sides—green=Spinach Salad/Stacy). The assigned to status information 348 has been updated to indicate that Joy is no longer responsible for this list item. The browser interface 344 has also informed the user that the changes are synced in display window 350 once an associated server or other component updates the shared Potluck Dinner Sign Up page 310 with the changes. For example, once the editing user has input changes, a call can be made to an application server to synchronize the changes with a prior version stored at the application server.

Depending on the implementation, synchronization operations can be configured to execute once the user hits “enter” or some other command or at specific intervals. Up to this point, the user (Stacy) has not opted to copy the shared Potluck Dinner Sign Up page 310 to personal notes. Once the changes are synchronized, the original page editor (Joy for this example) and other designated recipients are able view the associated changes and/or identities of the editing users as part of providing a collaborative notes page sharing experience.

Referring now to FIG. 3K, the original editor or creator (Joy for this example) of the shared Potluck Dinner Sign Up page 310 is using the notes application UI 300 to view another notes page, Walter's Birthday Party page 351 for this example. While viewing Walter's Birthday Party page 351, executable code of the notes application UI 300 has operated to provide a collaboration notification 352 informing Joy that a guest has updated the shared Potluck Dinner Sign Up page 310.

FIG. 3L depicts the notes application UI 300 after Joy has navigated back to the shared Potluck Dinner Sign Up page 310 to see that the assigned to status information 348 has been updated to indicate that a guest has edited the sides—green list entry. Accordingly, the notes application UI 300 is configured to display collaboration information regarding user edits to a shared notes page.

FIG. 3M depicts the notes application UI 300 providing another collaboration notification 354 informing Joy that another designated recipient (Lisa) has viewed the shared Potluck Dinner Sign Up page 310 for the first time. Thus, the notes application UI 300 is further configured to display collaboration information regarding user views of a shared notes page.

FIG. 3N depicts the notes application UI 300 as configured to provide yet another type of collaboration notification 356 informing Joy that another designated recipient (Jaime) has shared a new notes page. The newly shared page 358 is now populated in the page list 334 including a shared page editing indicator 336.

Referring now to FIG. 3O, the notes application UI 300 is shown after the user has selected the view link to the page control 318. For this example, selecting the view link to the page control 318 causes code to execute and display a dialog 360 to inform a user that the notes application or server is creating a view link to the selected notes page 361 for a recipe. As shown, the recipe notes page includes original notes page tags 362 (Recipe and Salad tags). As described above, the original notes page tags 362 can be transferred or copied over to a new shared notes pages for the recipe. In an embodiment, the notes application UI 300 is configured to send a request to a dedicated server to create a view link to an associated shared notes page. Once the request is received, the dedicated server is configured to generate a view link, such as a uniform resource locator (URL) for example, to the shared notes page and send a notification with the newly created view link to one or more designated recipients. The view link can be activated or cut and pasted into the browser to view the shared notes page.

FIG. 3P depicts the notes application UI 300 displaying a dialog 363 after the view link is created to the now shared notes page 361. The dialog 363 informs the user of the newly created view link along with the view link address. The user is also provided with an option to edit the notes page 361 with other users as well as an ability to share the newly created view link with other users. The notes application UI 300 is also displaying a newly added or associated shared tag 364 identifying the shared status of the shared notes page 361. A user can select the share view link control 365 and designate one or more other users to send the view link to. The share view link control 365 can be configured to bring up a share option that allows the user to send the view link using email, text messaging, or some other communication means. A view link icon 366 is shown with the shared notes page 361 to indicate that a view link is now associated with the shared notes page 361.

FIG. 3Q depicts a browser interface 367 that was used to display the shared notes page 361 after a user has selected the link or entered the URL into the browser. The user is given the option to copy the shared notes page 361 to personal notes or some other location. In an embodiment, a user may be required to sign-in in order to save a copy of the shared notes page 361. The shared notes page 361 for this example includes the original notes page tags 362. A shared tag is not yet displayed since the user has not shared the page with others at this point in time.

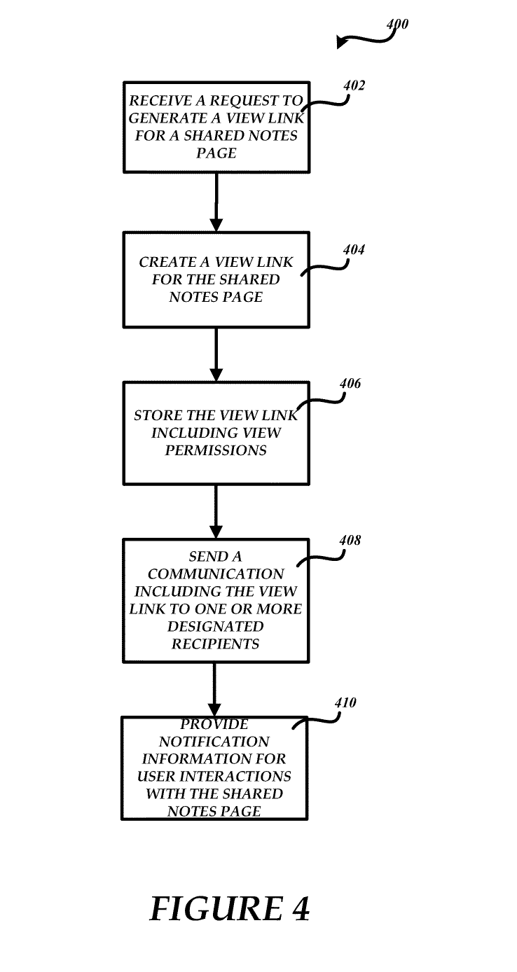

FIG. 4 is a flow diagram depicting an exemplary process 400 of providing a view link for a shared notes page. At 402, the process 400 operates to receive a request to generate a view link for a shared notes page. For example, at 402, a server can receive a request issued via a notes application running on a client device after a user issues a command that a view link be created for a selected notes page and disseminated to one or more designated viewers. At 404, the process 400 operates to create the view link for the shared notes page. For example, after receiving a request to create a view link, a server can be configured to create a new uniform resource locator (URL) along with a unique token and/or metadata for the shared notes page.

At 406, the process 400 operates to store the view link including one or more view permissions for the one or more designated viewers. At 408, the process 400 operates to send a communication including the view link to the one or more designated recipients or viewers. For example, after creating the view link, a server or another component can operate to generate and send an email or text message that includes the link to the one or more designated viewers.

At 410, the process 400 operates to provide notification information associated with user interactions with the shared notes page. For example, once a user uses the view link to visit and view the shared notes page, the interaction information can be captured and used in part to notify users of the user's view or other interaction. While a certain number and order of operations is described for the exemplary flow of FIG. 4, it will be appreciated that other numbers and/or orders can be used according to desired implementations.

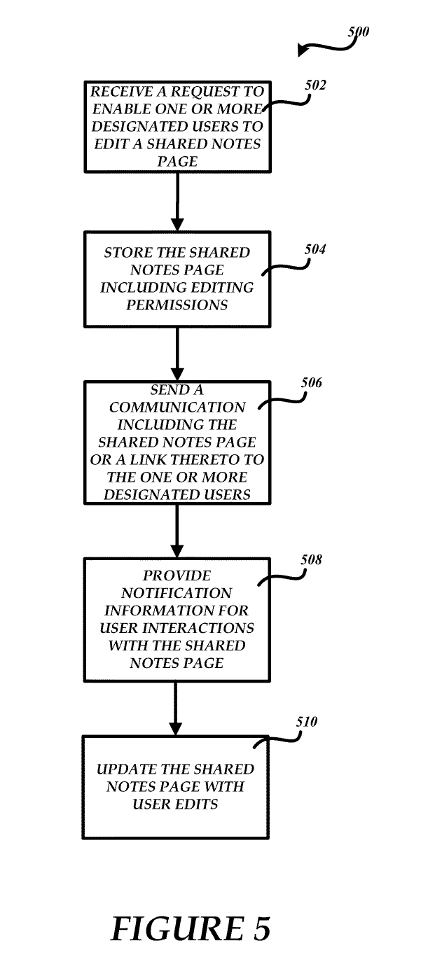

FIG. 5 is a flow diagram depicting an exemplary process 500 of enabling a user to share a notes page with one or more other users that are permitted to edit the shared notes page. At 502, the process 500 operates to receive a request to enable one or more designated users to edit a shared notes page. For example, at 502, a server can receive a request issued via a notes application running on a client device to allow other identified users to edit a selected notes page.

At 504, the process 500 operates to store the shared notes page along with any associated page-level permissions for the one or more designated users. At 506, the process 500 operates to send a communication including the shared notes page and/or a link thereto to the one or more designated users. For example, a server or another component can operate to generate and send an email or text message that includes the shared notes page to one or more designated editors along with an invitation to make edits to the shared notes page.

At 508, the process 500 operates to provide notification information associated with user interactions with the shared notes page. For example, notifications can be sent to the shared notes page originator and/or the one or more designated users as edits are made to the shared notes pages. At 510, the process 500 operates to update the shared notes page with any edits made to the shared notes page by the originator and/or one or more designated users. For example, a server can use notes page instance, metadata, and/or other information associated with the user edits to update the shared notes page with the user edits at designated times or intervals. While a certain number and order of operations is described for the exemplary flow of FIG. 5, it will be appreciated that other numbers and/or orders can be used according to desired implementations.

It will be appreciated that various features described herein can be implemented as part of a processor-driven computer environment including hardware and software components. Also, while certain embodiments and examples are described above for illustrative purposes, other embodiments are included and available, and the described embodiments should not be used to limit the claims. Suitable programming means include any means for directing a computer system or device to execute steps of a process or method, including for example, systems comprised of processing units and arithmetic-logic circuits coupled to computer memory, which systems have the capability of storing in computer memory, which computer memory includes electronic circuits configured to store data and program instructions or code.

An exemplary computer program product is useable with any suitable data processing system. While a certain number and types of components are described above, it will be appreciated that other numbers and/or types and/or configurations can be included according to various embodiments. Accordingly, component functionality can be further divided and/or combined with other component functionalities according to desired implementations. The term computer readable media as used herein can include computer storage media or computer storage. The computer storage of an embodiment stores program code or instructions that operate to perform some function. Computer storage media can include volatile and nonvolatile, removable and non-removable media implemented in any method or technology for storage of information, such as computer readable instructions, data structures, program modules, etc.

System memory, removable storage, and non-removable storage are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of a device or system. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components which include, but are not limited to, wide area networks (WANs), local area networks (LANs), metropolitan area networks (MANs), proprietary networks, backend networks, cellular networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Terms used in the description, such as component, module, system, device, cloud, network, and other terminology, generally describe a computer-related operational environment that includes hardware, software, firmware and/or other items. A component can use processes using a processor, executable, and/or other code. Exemplary components include an application, a server running on the application, and/or an electronic communication client coupled to a server for receiving communication items. Computer resources can include processor and memory resources such as: digital signal processors, microprocessors, multi-core processors, etc. and memory components such as magnetic, optical, and/or other storage devices, smart memory, flash memory, etc. Communication components can be used to communicate computer-readable information as part of transmitting, receiving, and/or rendering electronic communication items using a communication network or networks, such as the Internet for example. Other embodiments and configurations are included.

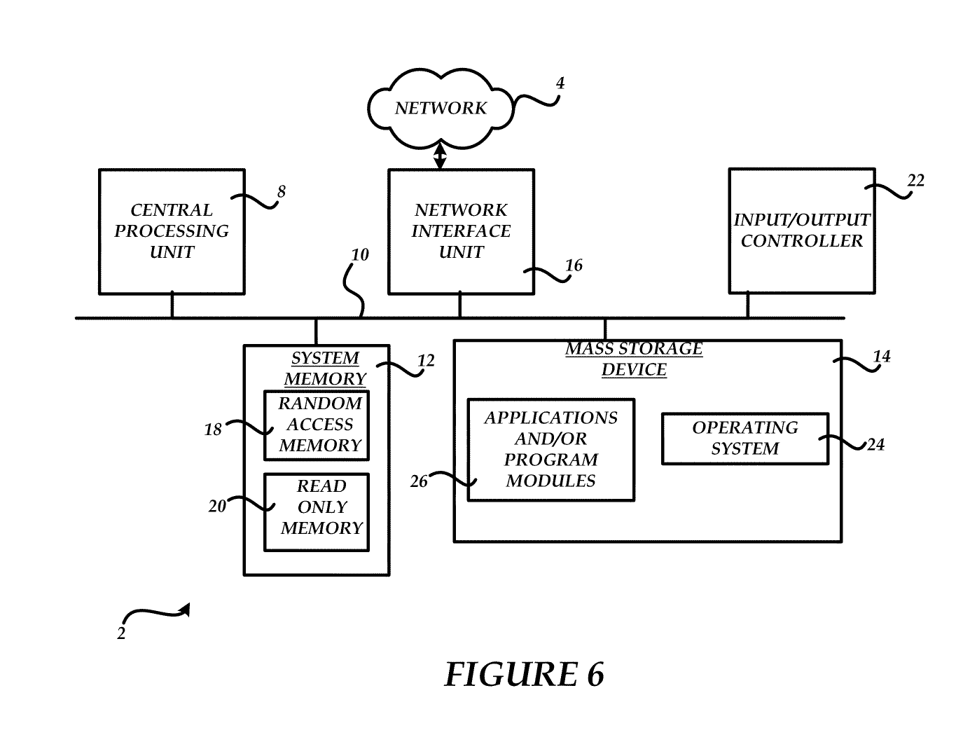

Referring now to FIG. 6, the following discussion is intended to provide a brief, general description of a suitable computing environment in which embodiments be implemented. While described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 6, computer 2 comprises a general purpose server, desktop, laptop, handheld, or other type of computer capable of executing one or more application programs including a notes application or other application that includes notes page sharing functionality. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules/resources 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

According to various embodiments, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

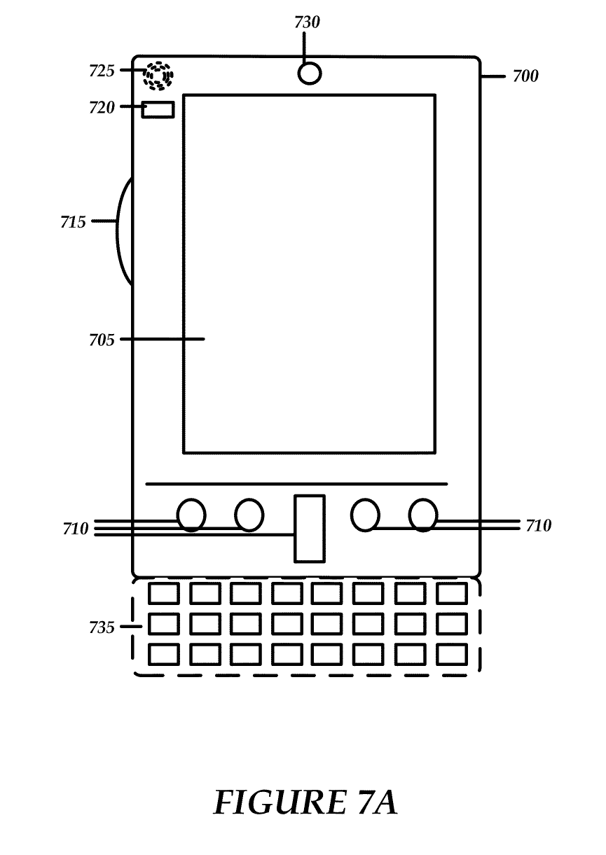

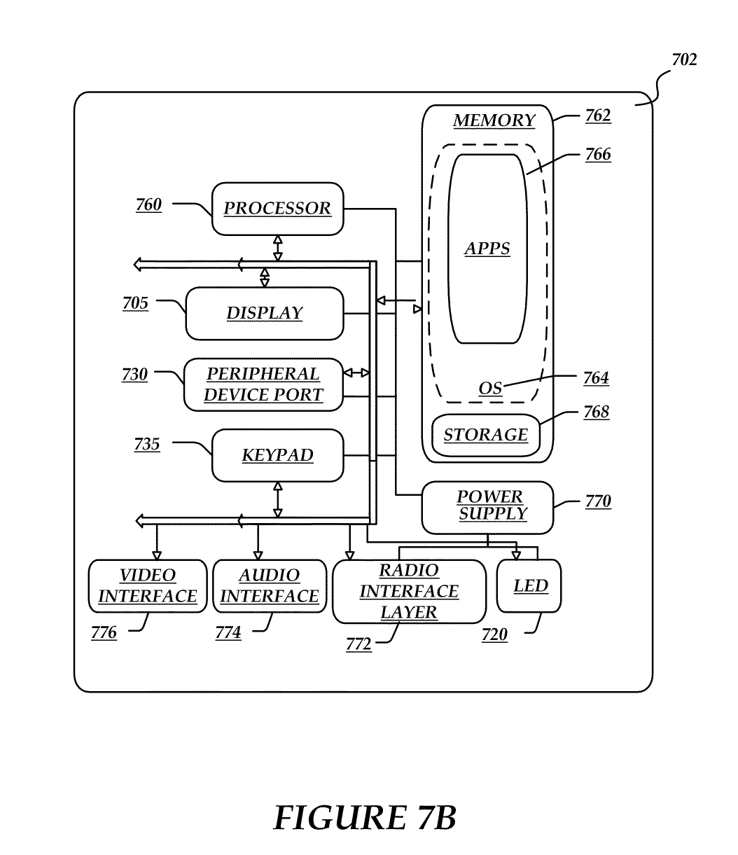

FIGS. 7A-7B illustrate a mobile computing device 700, for example, a mobile telephone, a smart phone, a tablet personal computer, a laptop computer, and the like, with which embodiments may be practiced. With reference to FIG. 7A, one embodiment of a mobile computing device 700 for implementing the embodiments is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments.

In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some embodiments, the mobile computing device 700 incorporates a vibration transducer for providing the user with tactile feedback. In yet another embodiment, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 700 can incorporate a system (i.e., an architecture) 702 to implement some embodiments. In one embodiment, the system 702 is implemented as a “smart phone” capable of running one or more applications (e.g., browser, e-mail, calendaring, contact managers, messaging clients, games, and media clients/players). In some embodiments, the system 702 is integrated as a computing device, such as an integrated personal digital assistant (PDA) and wireless phone.

One or more application programs 766, including a notes application, may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

The system 702 has a power supply 770, which may be implemented as one or more batteries. The power supply 770 might further include an external power source, such as an AC adapter or a powered docking cradle that supplements or recharges the batteries. The system 702 may also include a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 766 via the operating system 764, and vice versa.

The visual indicator 720 may be used to provide visual notifications and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

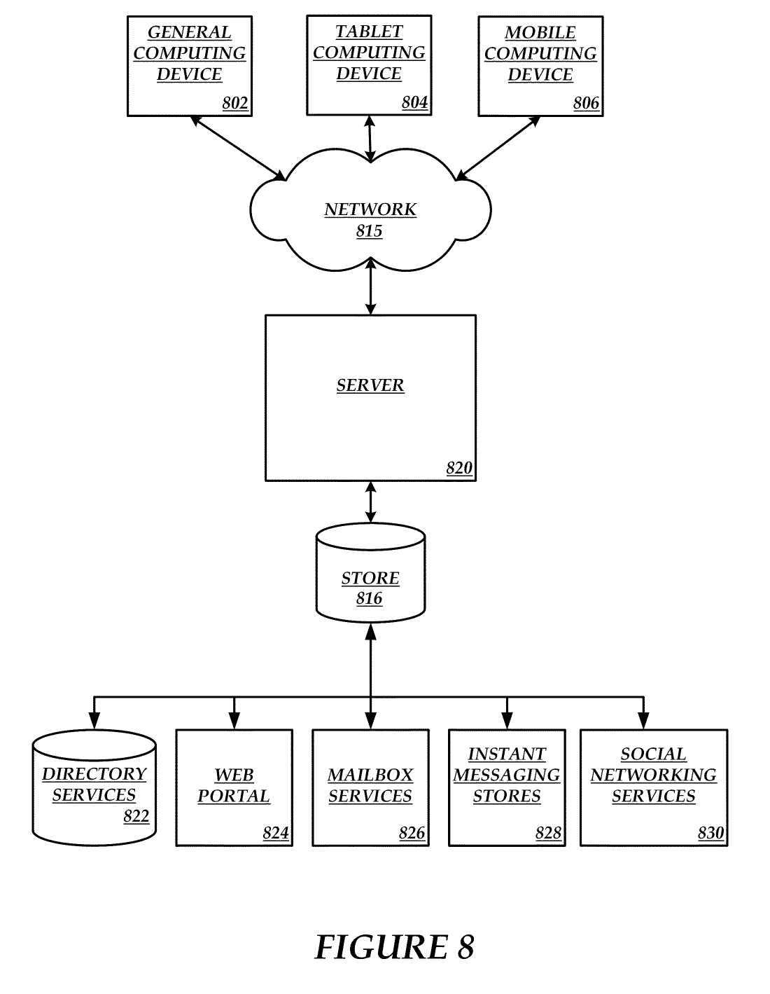

FIG. 8 illustrates one embodiment of the architecture of a system implementing notes sharing features with one or more client devices. Content, including notes page sharing information may be stored in different communication channels or other storage types. For example, various information may be stored using a directory service 822, a web portal 824, a mailbox service 826, an instant messaging store 828, and/or a social networking site 830. A server 820 may provide various notes page sharing features to communicating clients. As one example, the server 820 may be a synchronization server providing notes synchronization features over network 815, such as the Internet or other network for example. By way of example, the client computing device may be implemented as a general computing device 802 and embodied in a personal computer, a tablet computing device 804, and/or a mobile computing device 806 (e.g., a smart phone). Any of these clients may use content from the store 816.

Embodiments of the invention, for example, are described above with reference to block diagrams and/or operational illustrations of methods, systems, and computer program products. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

It should be appreciated that various embodiments can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method comprising:
using a notes application interface to create an electronic notes page having one or more original notes page tags;
using the notes application interface to share the electronic notes page with one or more other users as a shared electronic notes page, wherein the shared electronic notes page includes the one or more original notes page tags and page-level permissions corresponding to one of editing permissions and viewing permissions; and
using the notes application interface to display information associated with user edits or views while displaying the shared electronic notes page.

2. The method of claim 1, further comprising storing the shared electronic notes page in cloud storage including the page-level permissions.

3. The method of claim 1, further comprising using the notes application interface to identify permitted editors allowed to edit the electronic notes page and display identity information for corresponding edits made by the permitted editors.

4. The method of claim 1, further comprising using the notes application interface to create a view link to enable other users to view the shared electronic notes page absent editing permissions.

5. The method of claim 1, further comprising using a server computer to store the shared electronic note page along with the page-level permissions, and synchronize updates or edits made by permitted editors.

6. The method of claim 1, further comprising using the notes application interface to display a shared page tag to indicated a shared status of the shared electronic notes page.

7. The method of claim 1, further comprising using the notes application to save a copy of the shared electronic notes page to a personal notebook or other location, wherein the saving includes preserving a link of an original location of the electronic notes page using the same page level tags and permissions as the electronic notes page.

8. The method of claim 1, further comprising hosting the shared electronic notes page using the page-level permissions to enable the one or more other users to edit or view the shared electronic notes page.

9. A system configured to:
receive a request to share a notes page with one or more other users, the notes page including original content and one or more original notes page tags;
generate a shared notes page based in part on the original content and the one or more original notes page tags, wherein the system is configured to associate page-level permissions for the one or more other users to control whether the one or more other users can view or edit the shared notes page; and
provide a communication to the one or more other users indicating a sharing option or a viewing option for the notes page.

10. The system of claim 9, wherein the one or more other users can interact with the notes page using a browser application and various device types.

11. The system of claim 9, further configured to use a shared notes tag to identify a shared status of the shared notes page.

12. The system of claim 9, further configured to update the shared notes page with aggregated edits made by the one or more other users.

13. The system of claim 9, further configured to receive an identification of other editors who have made edits to the shared notes page.

14. The system of claim 13, further configured to display identity information associated with viewers of the shared notes page.

15. The system of claim 9, further configured to store the page-level permissions associated with the one or more other users.

16. A computer-implemented user interface for a notes application, the user interface configured to:
display a status of a shared notes page, including information associated with users permitted to interact with the shared notes page;
display one or more tags associated with the shared notes page, including a tag indicative of a shared state; and
display interaction information for the shared notes page of permitted users, including identity information associated with each editor or viewer.

17. The user interface of claim 16, further configured to enable the permitted users to share the page with other users.

18. The user interface of claim 16, further configured to display identity information associated with user edits made to the shared notes page.

19. The user interface of claim 16, further configured to provide an option of copying the shared notes page to a personal notebook.

20. The user interface of claim 16, further configured to display collaborative information regarding users who have interacted with the shared notes page.
